(19) United States
(12) Patent Application Publication
(10) Pub. No.: US 2007/0274642 A1
(43) Pub. Date: Nov. 29, 2007

(54) Optical transmission system

(75) Inventors: Takayoshi Inujima, Ashigarakami-gun (JP); Mikihiko Kato, Minato-ku (JP); Satoshi Takahashi, Minato-ku (JP); Yukiya Miyachi, Minato-ku (JP); Lionel C. Kimerling, Cambridge, MA (US); Jurgen Michel, Cambridge, MA (US); Dong Pan, Cambridge, MA (US); Wojciech P. Giziewicz, Cambridge, MA (US)

Correspondence Address: SUGHRUE MION, PLLC, 2100 PENNSYLVANIA AVENUE, N.W., SUITE 800, WASHINGTON, DC, 20037, US

(73) Assignees: FUJIFILM Corporation, Tokyo (JP); MASSACHUSETTS INSTITUTE OF TECHNOLOGY, Cambridge, MA (US)

(21) Appl. No.: 11/730,173

(22) Filed: Mar. 29, 2007

Related U.S. Application Data
(60) Provisional application No. 60/791,196, filed on Apr. 12, 2006.

(51) Int. Cl. G02B 6/36

(52) U.S. Cl. 385/88

(57) ABSTRACT

A high-speed optical transmission system includes an optical fiber for transmitting light and an optical receiver for receiving light transmitted from the optical fiber. The optical fiber is a plastic optical fiber (POF), and the optical receiver has a lateral pin structure.

### CROSS-REFERENCE TO RELATED APPLICATIONS

This application claims priority to U.S. Provisional Application Ser. No. 60/791,196, filed on Apr. 12, 2006.

### BACKGROUND OF THE INVENTION

1. Field of the Invention

The present invention relates to an optical transmission system. Particularly, the present invention relates to an optical transmission system including a large-diameter optical fiber for transmitting light and an optical receiver for receiving light from the large-diameter optical fiber, the optical receiver having a lateral pin structure

2. Description of the Related Art

The core diameters of single-mode optical fibers, which are mainly used in optical communication field, are small, namely approximately 9 μm. Therefore, it is necessary to use expensive parts, such as a highly accurate connector for connecting cables to each other at a joint therebetween. Hence, reduction in cost has been limited.

Therefore, in relatively-short-distance data communication field, multi-mode optical fibers are used. The core diameters of the multi-mode optical fibers are large. Therefore, even if there is a little scratch or a stain (dust) on an end of an optical fiber when the optical fibers are connected, or even if an optical axis is slightly shifted (mismatched), it is possible to transmit data using the multi-mode optical fibers. Further, it is possible to connect the optical fibers to each other or to other kinds of equipment using cheap parts. Further, since light loss due to bending is low, wiring of the multi-mode optical fibers is easy. Hence, it is possible to reduce cost.

However, if such multi-mode optical fibers are used, for example, in high speed communication at greater than or equal to 1 Gbps, problems arise both at a large-diameter optical fiber and at an optical receiver. Therefore, the conventional optical transmission systems cannot cope with further increase in communication speed. High communication speed is required because the capacity of networks has sharply increased in recent years, as typified by the Internet. Specifically, if the large-diameter optical fibers are used, increase in the transmission speed is limited because the transmission speed is affected by mode dispersion. Meanwhile, if a large-diameter pin photodiode is used in an optical receiver, parasitic capacitance increases. Therefore, a large RC time constant is produced, and thereby signals are delayed. Hence, increase in the transmission speed is limited. To prevent such limitation in increase of the transmission speed, a small-light-receiving-diameter pin photodiode for high speed data transmission may be used. However, if the light-receiving diameter is too small, connection loss occurs when the pin photodiode is directly connected to a fiber or the like, and sufficient sensitivity is not achieved. Further, a glass lens or a plastic lens may be added. However, it is impossible to add such a lens because that will increase cost.

### SUMMARY OF THE INVENTION

In view of the foregoing circumstances, it is an object of the present invention to provide a cheap optical transmission system that can transmit light at high speed.

A first optical transmission system of the present invention is an optical transmission system comprising:

an optical fiber for transmitting light therethrough; and

an optical receiver for receiving the light transmitted from the optical fiber. The optical fiber is a large-diameter optical fiber, and the diameter of the optical fiber is greater than or equal to 50 μm. Further, the optical receiver has a lateral pin structure.

A second optical transmission system of the present invention is an optical transmission system comprising:

an optical fiber for transmitting light therethrough;

an optical receiver for receiving the light transmitted from the optical fiber; and

an optical transmitter for sending light back to the optical fiber based on the light received at the optical receiver. The optical fiber is a large-diameter optical fiber, and the diameter of the optical fiber is greater than or equal to 50 μm. Further, the optical receiver has a lateral pin structure.

Here, the “large-diameter optical fiber” maybe a quartz fiber, a hard plastic clad optical fiber (HPCF) or a plastic optical fiber (POF). The “POF” includes a center portion (core), through which optical signals are transmitted, and a peripheral portion (clad), which surrounds the core. Generally, as a core material, it is desirable that the polymer of the core portion is a polymer that does not substantially have a C—H bond. It is more desirable that the polymer is a polymer in which deuterium and/or fluorine are substituted for C—H bonds. Specifically, an acrylic-based resin and/or a fluorine-based resin are used. Further, as a clad material, a fluorine-based resin or a resin that contains fluorine is used. The “lateral pin structure” is a structure in which P-type layers are formed between N-type layers that are spaced from each other on the same surface of the upper layer of a semiconductor substrate. In the lateral pin structure, an intrinsic semiconductor layer is provided between the N-type layer and the P-type layer.

Deuterium atoms or halogen atoms may be substituted for C—H bonds in molecules in the core of the POF. In this case, light loss is reduced, and long-distance transmission becomes possible.

The optical fiber may be a step-index fiber or a graded-index fiber. Here, the “step-index fiber” is an optical fiber of which the refractive index of the core is constant. The refractive index of the step-index fiber discontinuously changes only at the interface between the core and the clad. The step-index fiber includes a multi-step-index fiber, in which light propagates through the core by being divided into many modes (light propagation paths). The “graded-index fiber” is an optical fiber of which the refractive index of the core is smoothly distributed. The refractive index of the core continuously changes with respect to the radial direction. If the POF is a step-index fiber, since the core diameter of the step-index fiber is large and the step-index fiber is not easily affected by bending, it is possible to easily connect the optical fiber to another optical fiber or to some equipment. Further, since the step-index fiber can be easily produced and it is cheap, it is possible to reduce cost. Alternatively, if the POF is a graded-index fiber, the refractive index becomes lower as the distance from the center increases. Therefore, the speed of light increases as the distance from the center increases. Accordingly, it becomes possible to transmit light at constant propagation speed regardless of modes. Hence, it is possible to further increase the transmission speed.

The numerical aperture of the optical fiber may be greater than or equal to 0.2. The “numerical aperture” is the sine of the emission angle of light that propagates through an optical fiber at the maximum angle. If the numerical aperture of the POF is greater than or equal to 0.2, the light emitted from the POF can efficiently enter the optical receiver.

A distribution coefficient g of refractive indices of the optical fiber obtained by the following equation:

$$n ( r ) = {{n}_{1} [ 1 - 2 {Δ ( \frac{r}{a} )}^{g} ]}^{1 / 2} , 1 \leq r \leq a$$

may be within the range of 1.5 through 3 (here, n(r) is the distribution of refractive indices from the center of the core, n₁ is a refractive index at the center of the core, a is the radius of the core, and Δ is a relative refractive index). If the distribution coefficient of refractive indices of the optical fiber is in this range, the optical fiber is appropriate for high speed transmission. When the distribution coefficient of refractive indices is within the range of 1.5 through 3, a difference in delay time among propagation modes becomes small, and distortion of signals is reduced. Specifically, to increase the bandwidth of a multi-mode fiber, it is necessary that the core has appropriate distribution of refractive indices. However, if the distribution coefficient of refractive indices is greater than 3, delay in a high-order mode group becomes larger than delay in a low-order mode group, and distortion of signals increases. Further, if the distribution coefficient of refractive indices is less than 1.5, delay in the low-order mode group becomes larger than delay in the high-order mode group, and distortion of signals increases. If the core diameter is larger, the number of modes of propagation through the optical fiber increases. Therefore, to enable high-speed transmission, it is particularly important that the distribution of refractive indices is controlled so that a distribution coefficient of refractive indices that can minimize a difference in propagation delay with respect to all of propagation modes is maintained. Optionally, the distribution coefficient of refractive indices used in the optical transmission system of the present invention may be within the range of 1.5 through 3. Further optionally, the distribution coefficient of refractive indices may be within the range of 1.8 through 2.5, and still further optionally, within the range of 2.0 through 2.3.

Optionally, the wavelength of light transmitted through the optical fiber may be within the range of 770 nm through 860 nm. When the wavelength of light is in this wavelength band, light loss is low, and long-distance transmission becomes possible.

The optical receiver maybe made of Si, Ge or SiGe. Particularly, if the optical receiver is made of Ge or SiGe, the transmission speed can be further increased.

Optionally, the outer diameter of a light receiving portion of the optical receiver may be larger than that of the core portion of the optical fiber. If the outer diameter of the light receiving portion is larger than that of the core portion, more axial shift (misalignment) is allowable, and highly accurate optical axis adjustment is not necessary. Further, since light loss is low, a lens is not required. Hence, it is possible to reduce cost.

Further, light emitted from the POF is light of which the beam divergence within a predetermined distance after emission therefrom is narrower than that of light emitted in a conventional optical transmission system. Therefore, it is possible to optically connect the optical fiber and the optical receiver even if a gap of within the range of 150 μm to 500 μm is provided between a light-exiting end of the optical fiber and a light-receiving end of the optical receiver. In this case, work for optically connecting the optical fiber and the optical receiver becomes easy. Hence, it is possible to reduce cost.

The optical fiber and the optical receiver may be connected through resin. In this case, since transmission Loss is reduced, long-distance transmission becomes possible. Further, since reflected return light is reduced, high quality transmission with low noise becomes possible.

Further, it is possible to increase the transmission speed from the optical fiber to the optical receiver to 100 Mbps or greater by using the POF and the lateral pin structure in combination.

The optical transmitter may be a surface-emitting laser. The “surface-emitting laser” is also called VCSEL (vertical-cavity surface-emitting laser). The surface-emitting laser is a semiconductor laser in which the resonance direction of light is perpendicular to the substrate surface, and the direction of light emitted therefrom is also perpendicular to the substrate surface. If the optical transmitter is a surface-emitting laser, a cheap optical transmission system can be produced because the surface-emitting laser is suitable for mass production and the surface-emitting laser is cheap. Further, since it is not necessary that an end of the laser is formed by cleaving the surface thereof, it is possible to detect an initial failure by collectively judging whether a defect is present in wafers. Hence, it is possible to improve the production yield of lasers.

### BRIEF DESCRIPTION OF THE DRAWINGS

FIG. 1 is a schematic diagram illustrating an optical transmission system of the present invention; and

FIG. 2 is a perspective view of the optical transmission system of the present invention.

### DESCRIPTION OF THE PREFERRED EMBODIMENTS

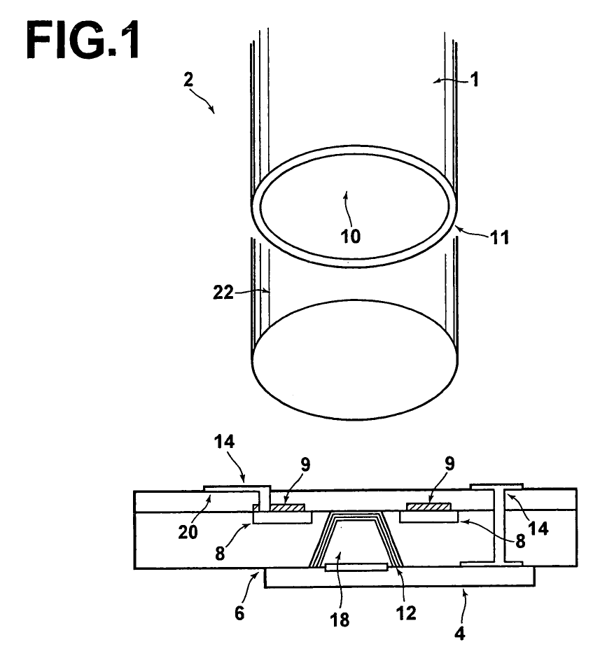

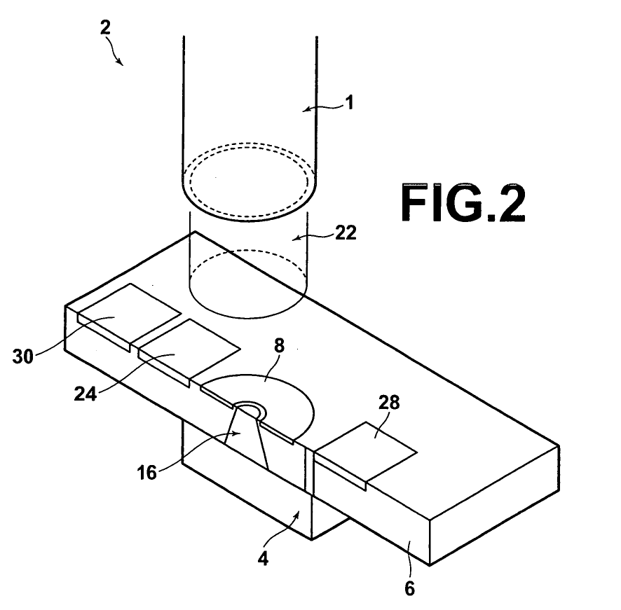

Hereinafter, preferred embodiments of the present invention will be described in detail with reference to the attached drawings. In FIG. 1 and FIG. 2, a plastic fiber (POF) is used as an optical fiber. However, the optical fiber may be other kinds of optical fibers, such as a quartz fiber and a hard plastic clad optical fiber (HPCF)

FIG. 1 is a diagram illustrating a specific embodiment of an optical transmission system of the present invention. As illustrated in FIG. 1, an optical transmission system 2 includes a POF 1 for transmitting light at high speed, a photodetector 8 for receiving light 22 incident thereon from the POF 1 and a VCSEL 4 for emitting light to the POF 1.

The POF 1 is a large-diameter optical fiber, and the diameter of the POF 1 is greater than or equal to 50 μm. The POF 1 includes a center portion (core) 10, through which optical signals are transmitted, and a peripheral portion (clad) 11, which surrounds the core 10. A polymer that forms the core 10 of the POF 1 is a highly-light-transmissive material. For example, the polymer that forms the core 10 may be a homopolymer selected from the group consisting of a polymer produced by using (meth)acrylic acid esters, such as fluorine-free (meth)acrylic acid ester and fluorine-containing (meth)acrylic acid ester, a styrene-based compound or vinylesters as a polymerizable compound, a fluorine-based polymer that includes a ring structure in its main chain, a polymer obtained by using bisphenol A, which is a raw material for polycarbonates, or the like as a polymerizable compound, and norbornene-based resin. Alternatively, the polymer that forms the core 10 may be a copolymer obtained by polymerizing at least two of the monomers and a mixture of the homopolymer(s) and/or the copolymer(s). Optionally, the core material may include (meth) acrylic acid esters as a polymerizable monomer. Further, when distribution of refractive indices is introduced through polymerization reaction by using refractive-index adjuster, it is desirable that an easily bulk-polymerizable material is used. Further, when an optical member is used for near-infrared rays, absorption loss is caused by C—H bonds included in the polymer forming the core portion. Therefore, it is desirable that a polymer in which deuterium atoms or halogen atoms (particularly, fluorine) are substituted for hydrogen atoms in C—H bonds in deuterated polymethyl methacrylate (PMMA-d8), polytrifluoroethyl methacrylate (P3FMA), polyhexafluoroisopropyl-2-fluoroacrylate (HFIP2-FA), polyperfluorobutanilvinylether, or the like is used. Accordingly, it is possible to change the wavelength band in which transmission loss occurs to a longer wavelength band, and it is possible to reduce loss of transmission signal light. Further, it is desirable that impurities and foreign bodies, which may become scatter sources, are sufficiently removed from raw material monomers before polymerization so that transparency (transmissive characteristic) is not lost after polymerization.

Further, the refractive index of the material for the clad 11 of the POF 1 is lower than that of the material for the core 10 so that light transmitted through the core portion is totally reflected at the interface between the core portion and the clad portion. It is desirable that the material for the clad 11 is a material that has an excellent adhesive characteristic to the core 10. If a mismatch tends to occur at the interface between the core portion and the clad portion by selection of materials, or if such selection of materials is not appropriate for production, an additional layer may be provided between the core portion and the clad portion to improve the matching characteristic therebetween. It is desirable that the material for the clad 11 is a material that has excellent toughness and excellent humidity-heat resistance. For example, the material for the clad 11 is a homopolymer or a copolymer of fluorine-containing monomers. Optionally, the fluorine-containing monomer may be vinylidene fluoride (PVDF). Further optionally, the material for the clad 11 may be a fluorine resin obtained by polymerizing at least one kind of polymerizable monomers that contain vinylidene fluoride at greater than or equal to 10 percent by mass.

A refractive-index adjuster may be used to form distribution of refractive indices in the core 10 of the POF 1. The refractive-index adjuster is a compound that has a refractive index different from that of the polymer forming the core portion. Further, if necessary, a refractive-index adjuster may be contained in polymerizable compositions for the clad portion. If the densities of the refractive-index adjuster are distributed, it is possible to easily produce a refractive-index-distribution-type core based on the distribution of the densities. In this case, it is desirable that a difference in refractive indices is greater than or equal to 0.005. Alternatively, the core portion may be formed by using at least two kinds of polymerizable monomers of which the refractive indices are different from each other without using the refractive index adjuster. In this case, it is possible to form distribution of copolymerization ratios in the core portion. Accordingly, it is possible to introduce refractive-index distribution structure to the core portion. An example of the polymerizable compound is tribromophenyl methacrylate. When a polymerizable compound is used as a refractive-index adjustment component, a polymerizable monomer and the polymerizable refractive-index component are copolymerized during formation of a matrix. Therefore, it becomes more difficult to control various kinds of characteristics, particularly optical characteristics. However, the use of the polymerizable compound as the refractive-index adjustment component is advantageous to the heat-resistant characteristic. If compounds obtained by substituting deuterium atoms for hydrogen atoms that are present in these compounds, it is possible to improve transparency in a wide wavelength band.

As methods for producing the POF 1, there are step-index type methods and graded-index type methods. One of examples of the step-index type methods is a method for spinning (forming) fibers by extruding a melted polymer or the like. Examples of the graded-index type methods, in other words, refractive-index-distribution type methods, are a method for producing the POF 1 from monomers and a method for producing the POF 1 from polymers. As the method for producing the POF 1 from the monomers, there is a method for condensing a refractive-index adjuster at the center of a smooth tube (hollow object) by inputting a monomer and a polymerizable composition that contains a refractive-index adjuster in the tube and by polymerizing them. There is also a method for producing the POF 1 by performing polymerization while inputting a polymerizable composition into a rotating cylindrical body or the like. In this method, the POF 1 is produced while the refractive indices of the polymerizable composition input to the cylindrical body are changed. Further, as the method for producing the POF 1 from the polymers, there is a method for depositing multiple layers in concentric circles by extruding resins of which the refractive indices are different from each other or resins in which the amounts of the refractive-index adjuster that has been compounded with the resins are different from each other from an outlet that has a concentric circle shape. There is also a method for diffusing the refractive-index adjuster in columnar or tube-shaped polymers, or the like. It is possible to obtain refractive-index-distribution-type fibers by using the aforementioned methods. If necessary, the diameter of the obtained fiber may be adjusted by melting the fiber by heat and by stretching the melted fiber so that the diameter of the fiber becomes a desired size. In this case, if a tube made of resin is arranged at the outermost circumference and the tube is simultaneously stretched, it is possible to provide a desired characteristic for the outermost layer. Fibers that are obtained as described above may be used as cables by further applying coating to the fibers in an appropriate manner for the purpose of the fibers.

The photodetector 8 has a comb-shaped lateral pin structure. The lateral pin structure is a structure in which P-type layers are formed between N-type layers that are spaced from each other on the same surface of the upper layer of a Si substrate 6. In the lateral pin structure, an intrinsic semiconductor layer is further provided between the N-type layer and the P-type layer. The photodetector 8 receives light 22 incident thereon from the POF 1. The photodetector 8 substantially has a circular structure, which conforms to the shape of the POF 1. The photodetector 8 is formed in a ring shape on the Si substrate 6. The diameter of the photodetector 8 is approximately 200 μm, and electrode width is approximately 1 μm. Further, the interval of electrodes is approximately 2μm. The electrodes may be metal electrodes. Alternatively, the electrodes may be transparent electrodes, such as electrodes made of indium tin or the like, to increase the numerical aperture. The lateral pin structure of the photodetector 8 is produced as follows. N-type substrates 6 are used, and a field oxide is grown by wet oxidation (also serving as dopant anneal step of the p implant). The contact regions are opened by dry etching, P and B implants are performed through two photoresist masks to form p+ region and n+ region, and the wafers are annealed for dopant activation. Ohmic finger contacts 9 are formed by sputter deposition of AlSi, patterning, dry etching, and sintering. A passivation layer 20 of SiO₂ is deposited by PECVD. Via openings to the ohmic contact metal 9 are patterned and etched. Finally, Al is sputter deposited, patterned, and dry-etched, forming contact pads 14 and filling the vias.

A VCSEL 4 is attached to the back side of the Si substrate 6 so as to be perpendicular to the Si substrate 6. The light emission wavelength of the VCSEL 4 is 850 μm or 780 μm. A hole 12 is formed on the back side of the Si substrate 6 by etching. Light generated at the VCSEL 4 is transmitted to the POF 1 through the hole 12. A contact point 14 made of metal is formed on the surface of the Si substrate 6 by evaporating metal on an SiO₂ layer 20, and the contact point 14 is electrically connected to the VCSEL 4. A multi-layer DBR (Distributed Bragg Reflector) 18 is evaporated on the inside of the hole 12. The multi-layer DBR 18 transmits light to the substrate 6. The VCSEL 4 generates an optical signal representing data to be transmitted (not illustrated). The photodetector 8 receives an input signal of an optical pulse from the POF 1, and generates a signal of an electric current pulse corresponding to the optical pulse. The electric current pulse signal is amplified in an electronic circuit and detected. The hole 12 and the DBR 18 transmit VCSEL light from the back side of the substrate 6 to the front side of the substrate 6. Then, the light enters the POF 1, and the light is guided to another light receiver. Then, the light is detected.

FIG. 2 is a perspective view illustrating an optical transmission system of the present invention. The photodetector 8 receives light 22 incident thereon from the POF 1. The optical transmission system 2 also includes a limiting amplifier 30, TIA (transimpedance amplifier) 24 and a drive element, such as a VCSEL driver 28, for driving the VCSEL 4.

The VCSEL driver 28 receives a voltage signal corresponding to a data signal to be transmitted. Then, the VCSEL driver 28 converts the voltage signal into an electric current signal and sends the converted electric current signal to the VCSEL 4. Accordingly, the VCSEL 4 is turned ON or OFF. Consequently, the VCSEL 4 emits an optical signal of 0 or 1 (namely, OFF or ON). The optical signal is converted into electric current by a photodiode, and further converted into a voltage signal by the TIA 24. The limiting amplifier 30 receives the voltage signal (normally, an output from the TIA 24) as an input, and generates an amplified voltage signal. An output from the limiting amplifier 30 is input to a digital circuit that is provided after the data transmission system. The limiting amplifier 30 may be formed on the same substrate in an integrated manner. Alternatively, the limiting amplifier 30 may be formed as a separate body.

Some preferred embodiments of the present invention have been described. However, various modifications, omissions and/or additions are possible without deviating from the concept and the scope of the present invention.

What is claimed is:

1. An optical transmission system comprising:
an optical fiber for transmitting light therethrough; and
an optical receiver for receiving the light transmitted through and exited from the optical fiber,
the optical fiber having a diameter greater than or equal to 50 μm, and the optical receiver having a lateral pin structure.

2. An optical transmission system as defined in claim 1, wherein the optical fiber is one of a plastic optical fiber (POF), a hard plastic clad optical fiber (HPCF) and a quartz fiber.

3. An optical transmission system as defined in claim 1, wherein the transmission rate from the optical fiber to the optical receiver is not less than 100 Mbps.

4. An optical transmission system as defined in claim 1, wherein the optical receiver is made of Ge or SiGe.

5. An optical transmission system as defined in claim 1, wherein the wavelength of the light exited from the optical fiber is within the range of 770 nm to 860 nm.

6. An optical transmission system as defined in claim 1, wherein the optical fiber is a plastic optical fiber (POF), and wherein the POF includes a core made of molecules, and one of a deuterium atom and a halogen atom is substituted for each C—H bond in the molecules.

7. An optical transmission system as defined in claim 1, wherein the optical receiver includes a light receiving portion, and the optical fiber includes a core, and the outer diameter of the light receiving portion is larger than that of the core of the optical fiber.

8. An optical transmission system as defined in claim 1, wherein the optical fiber is a plastic optical fiber (POF), and wherein the optical fiber and the optical receiver are optically connected to each other while a gap of within the range of 150 μm to 500 μm is provided between a light-exiting end of the optical fiber and a light-receiving end of the optical receiver.

9. An optical transmission system as defined in claim 1, wherein the optical fiber is one of a step-index fiber and a graded-index fiber.

10. An optical transmission system as defined in claim 1, wherein the numerical aperture of the optical fiber is not less than 0.2.

11. An optical transmission system as defined in claim 1, wherein a distribution coefficient g of refractive indices of the optical fiber obtained by the following equation:
$$n ( r ) = {{n}_{1} [ 1 - 2 {Δ ( \frac{r}{a} )}^{g} ]}^{1 / 2} , 1 \leq r \leq a$$
is within the range of 1.5 through 3, wherein n(r) is the radial distribution of refractive indices from the center of the core of the optical fiber, n₁ is a refractive index at the center of the core, a is the radius of the core, and Δ is a relative refractive index.

12. An optical transmission system as defined in claim 1, wherein the optical fiber and the optical receiver are connected to each other through one of a resin.

13. An optical transmission system comprising:
an optical fiber for transmitting light therethrough;
an optical receiver for receiving the light transmitted through and exited from the optical fiber; and
an optical transmitter for emitting light toward the optical fiber,
the optical fiber having a diameter greater than or equal to 50 μm, and the optical receiver having a lateral pin structure.

14. An optical transmission system as defined in claim 13, wherein the optical fiber is one of a plastic optical fiber (POF), a hard plastic clad optical fiber (HPCF) and a quartz fiber

15. An optical transmission system as defined in claim 13, wherein the optical receiver is made of Ge or SiGe.

16. An optical transmission system as defined in claim 13, wherein the wavelength of the light exited from the optical fiber is within the range of 770 nm to 860 nm.

17. An optical transmission system as defined in claim 13, wherein the optical fiber is a plastic optical fiber (POF), and wherein the POF includes a core made of molecules, and one of a deuterium atom and a halogen atom is substituted for each C—H bond in the molecules.

18. An optical transmission system as defined in claim 13, wherein the optical receiver includes a light receiving portion, and the optical fiber includes a core, and the outer diameter of the light receiving portion is larger than that of the core of the optical fiber.

19. An optical transmission system as defined in claim 13, wherein the optical fiber is a plastic optical fiber (POF), and wherein the optical fiber and the optical receiver are optically connected to each other while a gap of within the range of 150 μm to 500 μm is provided between a light-exiting end of the optical fiber and a light-receiving end of the optical receiver.

20. An optical transmission system as defined in claim 13, wherein a distribution coefficient g of refractive indices of the optical fiber obtained by the following equation:
$$n ( r ) = {{n}_{1} [ 1 - 2 {Δ ( \frac{r}{a} )}^{g} ]}^{1 / 2} , 1 \leq r \leq a$$
is within the range of 1.5 through 3, wherein n(r) is the radial distribution of refractive indices from the center of the core of the optical fiber, n1 is a refractive index at the center of the core, a is the radius of the core, and Δ is a relative refractive index.
